(19) United States
(12) Patent Application Publication
(10) Pub. No.: US 2013/0024159 A1
(43) Pub. Date: Jan. 24, 2013

(54) PARALLEL OUTLIER DETECTION

(71) Applicants: Amol Ghoting, Pomona, NY (US); Ferhan Ture, College Park, MD (US)

(72) Inventors: Amol Ghoting, Pomona, NY (US); Ferhan Ture, College Park, MD (US)

(73) Assignee: INTERNATIONAL BUSINESS MACHINES CORPORATION, Armonk, NY (US)

(21) Appl. No.: 13/186,777

(22) Filed: Jul. 20, 2011

(51) Int. Cl. G06F 19/00

(52) U.S. Cl. 702/179

(57) ABSTRACT

A method, system and computer program product for detecting outliers in a set of data points. In one embodiment, the method comprises partitioning the set of data points into a plurality of bins with each of the data points assigned to a respective one of the bins. A plurality of local lists are formed in parallel identifying points in the bins as outliers, and the local lists are merged into a global list to identify one or more of the points as outliers of the data set. Embodiments of the invention provide an outlier detection system that can parallelize in two levels. The dataset is split into partitions, called bins, and outliers are found in each bin in parallel. The execution of a single bin is also parallelized. Embodiments of the invention can scale to very large datasets by these two modes of parallelism.

### BACKGROUND OF THE INVENTION

The present invention generally relates to data analysis and more particularly, to outlier detection.

Outliers are points that are highly unlikely to occur, given the data distribution. In other words, an outlier is a data instance that does not comply with the underlying distribution.

Outlier detection is the problem of finding the outliers in a dataset. As available data increases, it is more important and challenging to automatically detect these unusual observations. An outlier can indicate noisy data, an interesting pattern, or malicious content. In any case, the information is valuable, which is why outlier detection has been applied to many real-life problems. Some of these applications are data cleaning, fraud detection, exploration in scientific databases, industrial process control, new interesting space object discovery, bio-surveillance, and airline safety.

Previously, research in outlier detection focused mainly on statistics-based parametric methods. In these approaches, the data is assumed to follow some known distribution, and parameters are estimated from data. Then, outliers can be detected as points too far from that distribution. There are several major drawbacks of using these methods. It is difficult to guess a good prior distribution and an arbitrary selection may hurt performance. Also, outliers in the data create noise when trying to fit the data into the assumed model.

Recently, data driven approaches have become more popular. Both supervised and unsupervised approaches have been studied for detecting outliers in a dataset. Although there are established supervised learning techniques that could be applied to this problem, the labeling quality and quantity is usually not sufficient for training a decent model. Related work in this area include using SVMs, Bayes-based approaches, and neural networks.

Since an increasing amount of data has become available, and labels are either unavailable or noisy, unsupervised outlier detection systems have been studied extensively.

Clustering has been used to find outliers: Outliers are either points not assigned to any cluster, farthest from the cluster centroid or points that form a small, sparse cluster. Many available clustering algorithms can be easily adapted into an outlier detection algorithm. However, the complexity of forming the clusters is a major obstacle for scalability.

Distance-based (or nearest neighbor based) techniques, which identify outliers as points that have fewest neighbors in a close range, have proven to scale near-linearly in practice. In these approaches, distance is measured by one of the commonly used distance metrics, and the following among others is a popular definition of an outlier: Outliers are top m points that have greatest distance to their k^{th} nearest neighbor.

The core idea to find outliers in a distance-based method is to do a nested loop (NL) on the data points, in which every point is compared against all others. A list of the k nearest neighbors is maintained for every point. When the loop terminates, the points farthest from their k^{th} nearest neighbor are the top outliers of the dataset. Many of the related works extend this NL idea in order to improve its quadratic scaling behavior.

Bay and Schwabacher develop an approach to find outliers using the NL method more efficiently. (Stephen D. Bay and Mark Schwabacher. Mining distance-based outliers in near linear time with randomization and a simple pruning rule. Proceedings of the ninth ACM SIGKDD international conference on Knowledge discovery and data mining, pages 29-38, 2003). They show that randomization and very simple pruning techniques can make a big difference in practical complexity. A point is pruned from candidate outliers if it has at least k neighbors closer than the cutoff value (i.e., weakest outlier's distance to its k^{th} nearest neighbor). This technique requires only constant running time for the majority of points, and therefore has near-linear scaling performance. However, the scaling performance of the algorithm depends strongly on the condition that the cutoff value increases with respect to the dataset size. This condition is true only if there are many outliers, and this may not hold for many datasets.

Ghoting et al. base their work on the same ideas as Bay and Schwabacher, and build on the deficiency of ORCA. (Amol Ghoting, Srinivasan Parthasarathy, and Matthew Eric Otey. Fast mining of distance-based outliers in high dimensional datasets. Proceedings of the Sixth SIAM International Conference on Data Mining, Apr. 20-22, 2006, Bethesda, Md., USA). The only difference is an additional pre-processing step where the dataset is split into partitions, such that every point's nearest neighbors are in the same partition with high probability. Their algorithm called RBRP processes the dataset partition by partition, by which every point is compared to its neighbors quickly. This addition improves time complexity by over an order of magnitude for some data sets. The authors show that the theoretical improvement (O(N log N) average vs quadratic) reflects in practice on every dataset they have experimented with.

Angiulli and Fassetti use an index to maintain a summary of the dataset in their algorithm. (Fabrizio Angiulli and Fabio Fassetti. Dolphin: An efficient algorithm for mining distance-based outliers in very large datasets. ACM Trans. Knowl. Discov. Data, 3:1, 2009). The algorithm basically does two scans of the dataset; in the first scan, points that are definitely not outliers are filtered and in the second scan, the exact top outliers are determined. Authors state that the algorithm has linear scale in certain conditions, and is much more efficient than ORCA in practice. However, the experiments are run on low-dimensional and synthetic datasets, instead of the more challenging datasets used in the previous two papers.

Knorr, Ng and Tucakov present a cell-based approach to outlier detection, in which the idea is to process the dataset cell-by-cell, as opposed to tuple-by-tuple. (Edwin M. Knorr, Raymond T. Ng, and Vladimir Tucakov. Distance-based outliers: Algorithms and applications. VLDB Journal, 2000). Authors report that the algorithm scales well only for datasets with at most 4 dimensions.

Yankov et al. show that a quick, approximate cutoff calculation can decrease the runtime significantly. The initial cutoff is used to prune the search space in one scan, and a second scan finds the exact outliers (Dragomir Yankov, Eamonn Keogh, and Umaa Rebbapragada. Disk aware discord discovery: finding unusual time series in terabyte sized datasets. Knowl. Inf. Syst., 17(2):241-262, 2008).

### BRIEF SUMMARY

Embodiments of the invention provide a method, system and computer program product for detecting outliers in a set of data points. In one embodiment, the method comprises partitioning the set of data points into a plurality of bins, where each of the data points is assigned to a respective one of the bins, and each of the bins has less than a defined number of the data points; forming a plurality of local lists in parallel identifying a plurality of the points in the bins as outliers, each of the local lists identifying one or more outliers in a respective one of the bins; and merging the local lists into a global list to identify one or more of the points in the set of data points as outliers of the data set.

In one embodiment, the plurality of local lists area formed by identifying, for each point in each of the bins, a k number of the other points in the data set that are the k nearest neighbors of said each point. In an embodiment, forming the plurality of local lists further includes, for each of at least some of the points in each of the bins, maintaining a knn list of the k nearest neighbors of said each of the at least some of the points; and using the knn lists to determine the one or more outliers of each of the bins.

In an embodiment, the local lists are merged into the global list by identifying all of the outliers of each of the bins on the global list, and using the knn lists of said all of the outliers of each of the bins to identify a group of top outliers of the data set.

In one embodiment, the identifying the k nearest neighbors includes determining for each of the points in each of the bins, other points in said each of the bins that cannot be one of the k nearest neighbors of said each point. In an embodiment, the identifying the k nearest neighbors includes determining for each of at least some of the points in the data set, whether all of the points in any one of the bins cannot be one of the k nearest neighbors of said each of at least some of the points.

In an embodiment, the plurality of local lists are formed by, for each point in the data set, keeping track of the number of other points in the data set that are closer than a defined distance to said each point. In one embodiment, forming the plurality of local lists further includes, for each point in the data set, when said number of other points in the data set that are closer than the defined distance to said each point exceeds a defined value, eliminating said each point from further consideration as an outlier.

In one embodiment, forming the plurality of local lists further comprises iterating over the bins a plurality of times to identify the other points in the data set that are closer than the defined distance to said each point; and in the first of said iterations, setting said defined distance to zero. In an embodiment, forming the plurality of local lists further comprises, in each of said iterations after said first of the iterations, updating said defined distance one or more times.

Embodiments of the invention provide an outlier detection system that can parallelize in two levels. An embodiment of the invention splits the dataset into partitions (called bins) in parallel, and finds outliers in each bin in parallel. Moreover, in an embodiment, the execution of a single bin is also parallelized. Finally, in one embodiment, the invention merges the outliers from each bin into a global set of outliers. Embodiments of the invention can scale to very large datasets by these two modes of parallelism.

### BRIEF DESCRIPTION OF THE SEVERAL VIEWS OF THE DRAWINGS

FIG. 1 gives an overview of a binning phase used in an embodiment of the invention.

FIG. 2 shows a procedure that, in an embodiment of the invention, determines which bins to filter out when processing a bin Bᵢ.

FIG. 3 illustrates a procedure used, in an embodiment of the invention, to count the number of neighbors in a cut off range for every point in a bin, and to determine the inliers using those counts.

FIG. 4 shows a procedure for, in an embodiment of the invention, finding the top outliers of a bin.

FIG. 5 gives an overview of the bin processing phase of an embodiment of the invention.

FIG. 6 depicts a computer system that may be used in the implementation of the present invention.

### DETAILED DESCRIPTION

As will be appreciated by one skilled in the art, embodiments of the present invention may be embodied as a system, method or computer program product. Accordingly, embodiments of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, embodiments of the present invention may take the form of a computer program product embodied in any tangible medium of expression having computer usable program code embodied in the medium.

Any combination of one or more computer usable or computer readable medium(s) may be utilized. The computer-usable or computer-readable medium may be, for example but not limited to, an electronic, magnetic, optical, electromagnetic, infrared, or semiconductor system, apparatus, device, or propagation medium. More specific examples (a non-exhaustive list) of the computer-readable medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CDROM), an optical storage device, a transmission media such as those supporting the Internet or an intranet, or a magnetic storage device. Note that the computer-usable or computer-readable medium could even be paper or another suitable medium, upon which the program is printed, as the program can be electronically captured, via, for instance, optical scanning of the paper or other medium, then compiled, interpreted, or otherwise processed in a suitable manner, if necessary, and then stored in a computer memory. In the context of this document, a computer-usable or computer-readable medium may be any medium that can contain, store, communicate, propagate, or transport the program for use by or in connection with the instruction execution system, apparatus, or device. The computer-usable medium may include a propagated data signal with the computer-usable program code embodied therewith, either in baseband or as part of a carrier wave. The computer usable program code may be transmitted using any appropriate medium, including but not limited to wireless, wireline, optical fiber cable, RF, etc.

Computer program code for carrying out operations of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

The present invention is described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer program instructions may also be stored in a computer-readable medium that can direct a computer or other programmable data processing apparatus to function in a particular manner, such that the instructions stored in the computer-readable medium produce an article of manufacture including instruction means which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide processes for implementing the functions/acts specified in the flowchart and/or block diagram block or blocks.

Embodiments of the invention provide a method, system and computer program product utilizing a two phase procedure to efficiently detect outliers in a large, high-dimensional dataset. The general overview of an embodiment is as follows: The first phase partitions the dataset into bins such that points closer to each other are more likely to be assigned to the same bin. Every point is assigned to exactly one bin and each bin is less than a certain size. The second phase finds the outliers in each bin separately and then merges these outliers into a global set of outliers.

The algorithm is designed to exploit parallel computation without compromising efficiency and effectiveness.

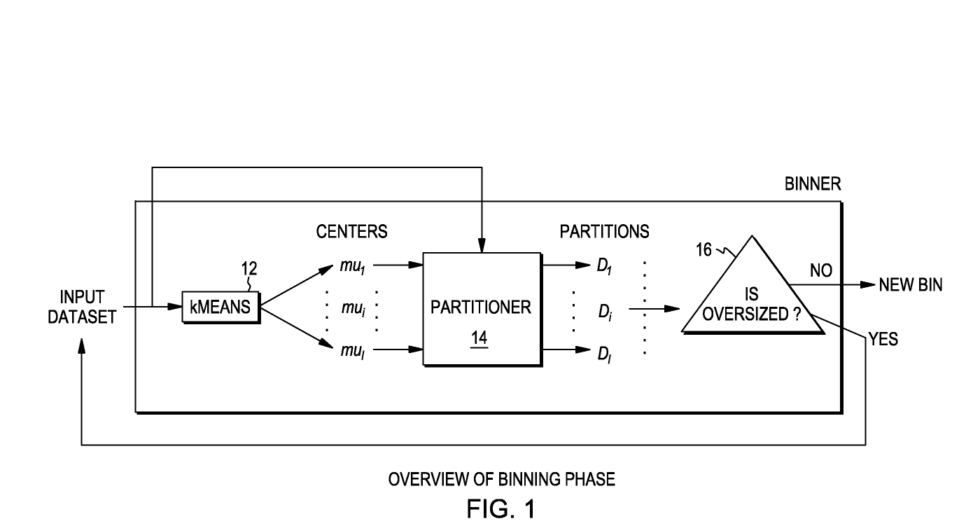

FIG. 1 illustrates the binning process. The goal of the binning phase is to group points with their approximate nearest neighbors, and to split the data into smaller units that can be processed independently. A parallel version of k-means clustering 12 is applied to the dataset recursively, until all clusters are smaller than a specified size. At each step of the process, the dataset is partitioned at 14 into k clusters using the usual k-means approach. Then, the algorithm is called recursively at 16 on all clusters that exceed the maximum bin size. The phase is finished when the entire dataset has been partitioned into proper-sized bins β=B₁, . . . , B₁ successfully.

As a result of this phase, each bin is a compact set of points that contains many close neighbors and can fit into memory. This allows a much faster, in-memory pruning in the second phase, when many of the points in a bin are pruned just by counting “local” neighbors (Hereafter, a neighbor is called local if it is in the same bin, and global otherwise). Another advantage is that each bin can be processed independently and in parallel. For example, the outliers in B₁ can be found by processing B₁ against the dataset. Simultaneously, B₂ can be processed against the dataset in a separate task. As input gets very large, parallelization is the most effective solution for scalability.

The second phase finds the “top” M outliers of the entire dataset, where an outlier is measured by the distance to its k^{th} nearest neighbor. In other words, if all points are sorted from high to low by the distance to their k^{th} nearest neighbor, the M points at the top of the list are the outliers sought by the algorithm. In order to find the top outliers in the dataset, the top outliers of each bin are found in parallel and all lists are merged into a global list. The discussion below describes in detail how to find the outliers of a given bin B₁, and gives details about the merging procedure.

A straightforward approach for finding outliers of a bin is to load Bᵢ into memory, and maintain a list of k nearest neighbors (knn-list) for every point in B₁. Then, for every point in the dataset, say xεD, the distance from x to every point in the bin is calculated and the corresponding knn-list is updated. This approach does the same number of computations as the simple NL algorithm. However, the advantage is that the input can be processed in parallel: In the MapReduce framework, every map function processes one point xεD, and the reducer merges the knn-lists from different mappers together. The algorithm iterates over each knn-list and maintains a list of the M points with farthest k^{th} nearest neighbors.

### Filtering Bins

In order to correctly find outliers in a bin, one needs to find the knn-list of each point in the bin. To find the knn-list of a point p in the bin, one needs to go through all neighbors of p in D and sort them by their respective distance. This requires |Bᵢ|×|D| distance calculations to find the top outliers of bin Bᵢ.

Since outlier detection is a computation-bound algorithm rather than an IO-bound one, a goal is to reduce the number of distance calculations. A distance calculation requires floating point operations linear to the number of dimensions, and is the major computation unit of the algorithm. A distance calculation with some xεD can only be prevented if it is known that x will not be among the k nearest neighbors of p. Extrapolating from this idea, if a way can be found to determine if all points in some bin Bⱼ cannot be in the knn-list of any point in Bᵢ then Bⱼ can be discarded from the processing of Bᵢ.

Thus, the following condition can be stated: Bin Bⱼ is not needed when finding outliers in bin Bᵢ, if for all pεBᵢ, the point in Bⱼ closest to p is farther than the point in Bᵢ farthest to p. If this holds, all points in Bᵢ are closer to p than any point in Bⱼ. Assuming that all bins have more than k points, this implies that no point in Bⱼ can be in the knn-list of p. However, checking this condition holds is as hard as finding the outliers, because it requires the distance between every pair.

It can be proven that the condition holds for all points without actually iterating through them, by using the center of Bᵢ(μᵢ) as a summary of its points.

The following argument can be stated: Assume d is a proper metric distance and the distance between points x and y is denoted by d_{x,y}. Let M=max_{xεB}_{ᵢ}d_{x,μ}_{ᵢ}. If Min_{xεBi}d_{x,μi}>3M, then ∀pεBᵢ, min_{rεB}_{ⱼ}_{d}_{_{p,r}}>max_{qεB}_{ᵢ}d_{_{p,q}} (This result is equivalent to the condition above.)

Proof: Take any point p in Bᵢ and let r*=arg min_{xεB}_{ⱼ}d_{p,x} and q*=arg max_{qεB}_{ᵢ}d_{p,q}. Show that

d_{p,r*}>d_{p,q*} (1)

By triangular inequality on the left hand side of Eq. 1,

d_{p,r*}≧(d_{μ}_{ᵢ}_{,r*}−d_{μ}_{ᵢ}_{,p}) (2)

By plugging in the inequalities d_{μ}_{_{i, r*}}>min_{xεB}_{ⱼ}d_{x,μ}_{ᵢ}>3M and d_{μ}_{ᵢ}_{,p}≦max_{xεB}_{ᵢ}d_{x,μ}_{ᵢ}=M it can be concluded that d_{p,r*}>2M.

By triangular inequality on the right hand side of Eq. 1,

d_{p,q*}≦d_{p,μi}+d_{μi,q*}≦2M (3)

By combining Eq. 2 and Eq. 3, we conclude the argument:

d_{p,q*}≦2M<d_{p,r*}

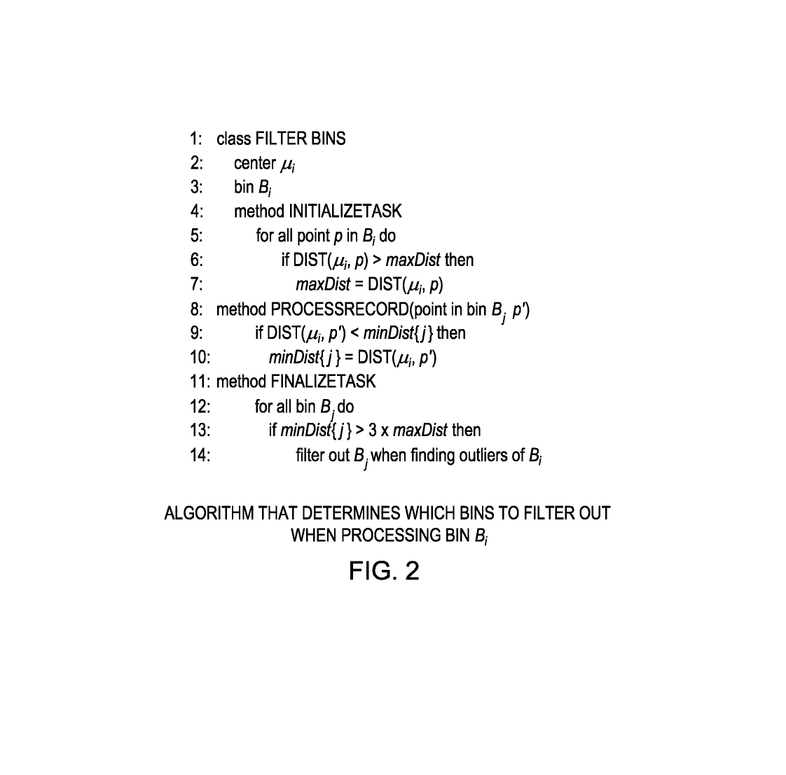

FIG. 2 shows the procedure that, in an embodiment of the invention, determines which bins to filter out when processing bin Bᵢ. In order to filter unnecessary bins when finding outliers in bin Bᵢ, the algorithm loads Bᵢ and its center μᵢ into memory. The maximum distance from any point in Bᵢ to μᵢ is found (Lines 4-7). For all other bins Bⱼ, the minimum distance between any point in Bⱼ and μᵢ is calculated (Lines 8-10). If this distance is more than three times the former distance, Bⱼ is discarded (Lines 11-14). The total number of computations to perform filtering for Bᵢ is |D|. For future reference, let βᵢ be the set of bins required to find outliers in Bᵢ.

The filtering step helps to provide an efficient parallelization. By filtering out redundant work, the procedure prevents the case in which some of the computational resources are wasted by processing some portion of the dataset that does not contribute to the output. In very large datasets with many bins, this optimization becomes more important.

### Pruning Inliers

Using a cutoff value to prune inliers and save computations is a technique studied by other outlier detection approaches. (Stephen D. Bay and Mark Schwabacher, Mining distance-based outliers in near linear time with randomization and a simple pruning rule, Proceedings of the ninth ACM SIGKDD international conference on Knowledge discovery and data mining, pages 29-38, 2003; Amol Ghoting, Srinivasan Parthasarathy, and Matthew Eric Otey, Fast mining of distance-based outliers in high dimensional datasets, Proceedings of the Sixth SIAM International Conference on Data Mining, Apr. 20-22, 2006, Bethesda, Md., USA. The idea originates from the observation that the weakest of the top M outliers (i.e., the one with lowest k^{th} nearest neighbor distance) can be used as a cutoff point. For example, let C be the distance from the weakest outlier to its k^{th} nearest neighbor. A point in the dataset is an inlier if it has more than k neighbors within C. Once a point is known to be an inlier, the computation for that point can be stopped. As new outliers are discovered and the top M outliers change, the cutoff value C is increased. A higher cutoff lets the algorithm identify inliers earlier.

Before finding outliers in a bin, the above technique is applied to identify inliers and remove them from the bin. The remaining points are then piped into the next task to find the top outliers. There is a specific reason why pruning and outlier detection may, in embodiments of the invention, be separate tasks in a parallel algorithm.

In a serial outlier detection algorithm, pruning is performed as the algorithm proceeds; pruning and outlier detection can be done at once since everything is loaded into memory. Once a point is known to be an inlier, it is removed from further processing but the rest continues uninterrupted. However, in a MapReduce algorithm, data is distributed to mappers, and information cannot be shared among mappers. Since every mapper only knows the result from a part of the input, all mappers should complete their work before all of the information can be aggregated. This is the motivation to separate the pruning step and the outlier detection algorithm: The former prunes inliers from the bin, and the latter finds top outliers among the remaining points.

The pruning of a bin starts with an initialization step where local neighbors are counted. Since the bins contain approximate nearest neighbors, many inliers can be detected just by counting their local neighbors. As the entire bin is in memory, this step runs in memory and sequentially.

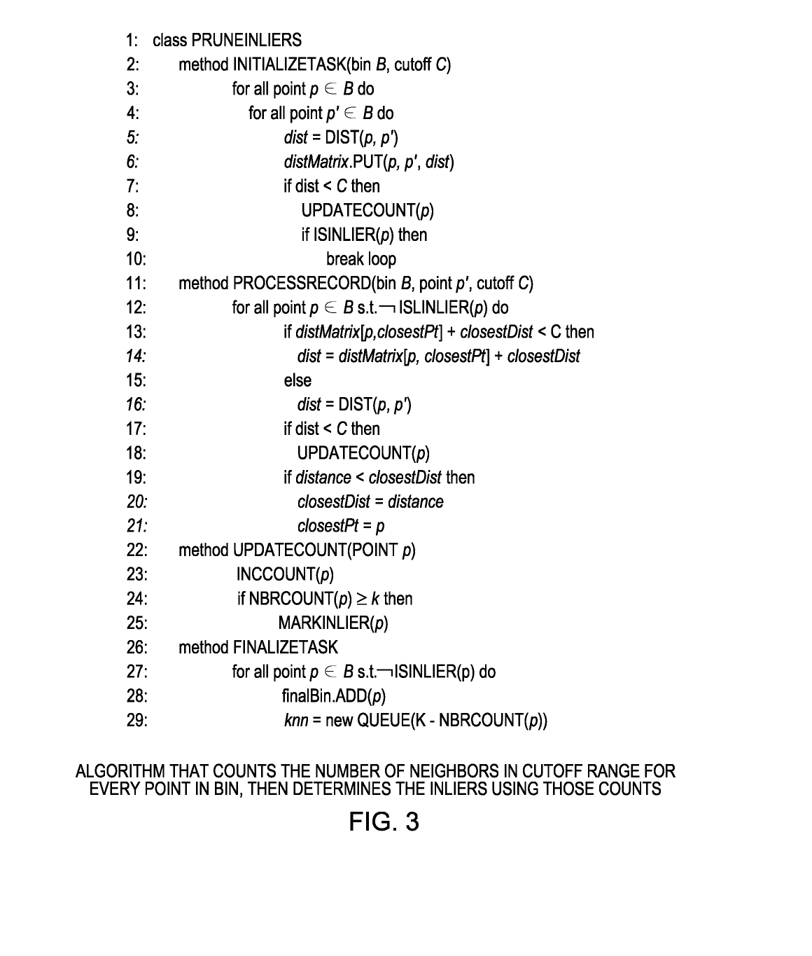

FIG. 3 shows a procedure used in an embodiment of the invention to count the number of neighbors in a cut off range for every point in a bin and to determine the inliers using those counts.

During the initialization, for every point pεBᵢ, the algorithm keeps track of the number of local neighbors of p closer than C. If the count exceeds K, the point is marked as an inlier and the loop is terminated for that point (Lines 7-10). If triangular inequality heuristic is enabled, a matrix is filled with all pairwise distance calculations in the bin (Line 6). After the initialization is done, the input βᵢ, is distributed among mappers. Each map function processes a single point x from βᵢ, and iterates over the bin in memory (discarding inliers) to update each point's neighbor count (Lines 17-18).

One way to avoid distance calculations is to use saved distances and the triangular inequality principle. When processing input x, for each point p in the bin, if there is another point p′ in the bin, such that d_{p′,x}+d_{p,p′}<C, then d_{p,x}<C and it is not necessary to calculate the actual distance. Instead of searching for all candidate points p′, as a heuristic, only one distance is stored for x: the point in Bᵢ closest to x so far. As d_{p,p′} is always available through the distance matrix, this heuristic can be applied in constant time. If the heuristic does not apply, then the actual distance between x and p is calculated (Lines 13-16). The closest point to x may be updated after every distance calculation (Lines 19-21).

After all of the mappers complete, the neighbor counts from every mapper (for each point in the bin) are accumulated to find the total number of neighbors within cutoff range. The finalization step has two purposes: (1) To prune the bin so it contains only non-inliers (Lines 27-28), and (2) to create a knn-list for every non-inlier point. In order to reduce the memory footprint, instead of maintaining a queue of capacity K for every point in the bin, only distances to neighbors outside the cutoff range are stored. Neighbors closer than C are already counted and are guaranteed to be at the front of the queue, so there is no need to physically store them (Line 29). The pruned bin and knn-lists are then passed on to the next MapReduce job (finding outliers) as a parameter.

### Finding Outliers

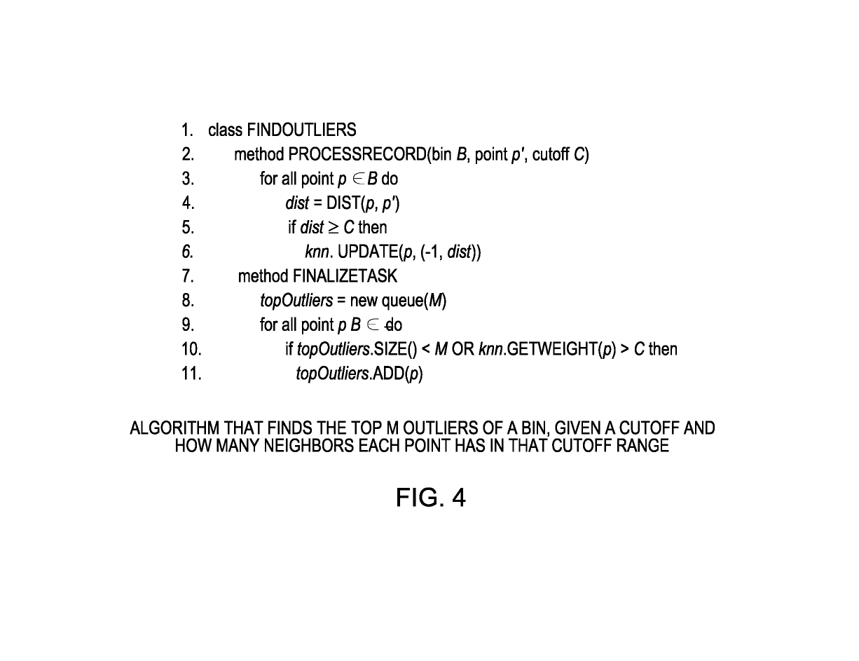

After unnecessary bins are filtered and inlier points are pruned from the bin, top outliers are found among the remaining candidates. FIG. 4 illustrates a procedure for, in an embodiment of the invention, finding the top M outliers of a bin, given a cut off and how many neighbors each point has in that cut off range. The straightforward NL algorithm is run on each bin Bᵢ: A knn-list is maintained for every point in the bin, as the algorithm scans through all bins in βᵢ as well as Bᵢ itself (Lines 3-6). The knn-list of every point was created in the PRUNEINLINIERS task. After the entire input is processed by mappers, the knn-lists are merged into one global list of k nearest neighbors for every point. All points are then stored by the distance to their k^{th} nearest neighbor and the highest M are output as top outliers. The cutoff value is updated to the weakest outlier's k^{th} nearest neighbor distance (Lines 8-11).

The knn-list is implemented as a queue of (id, distance) entries. An id is used for the neighbor which is being added so that the queue can distinguish local and global neighbors at exactly the same distance. For local neighbors, the array index of the point is used as the id, and for global neighbors, −1 is used. Notice that there is no problem distinguishing two global neighbors at same distance because they will be output by two different mappers. The problem is due to all mappers sharing the same local neighbors in their respective knn-lists.

### Overview

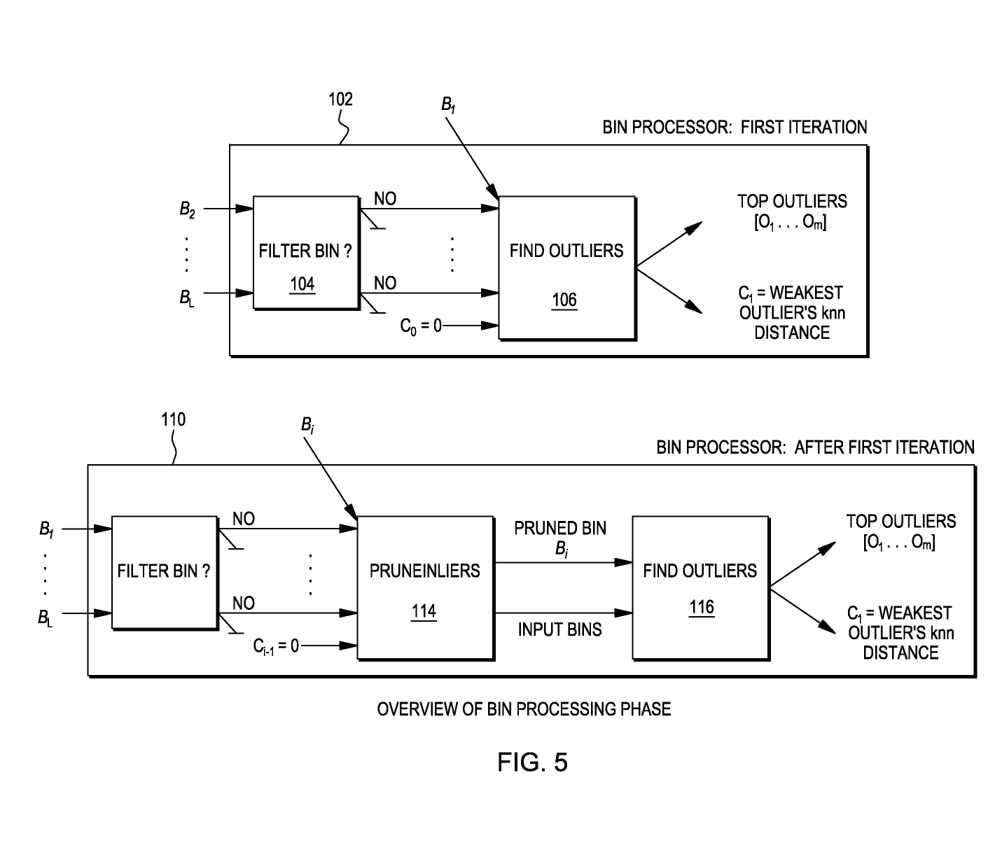

FIG. 5 gives an overview of the bin processing phase. In the first iteration, represented at 102, there is no pruning step since the cutoff value is initialized to 0. Bins are filtered at 104 from the dataset (FIG. 2), and then top outliers are found at 106 (FIG. 4). In later iterations, represented at 110, the bin is pruned at 114 from inliers before outliers are found at 116 (FIG. 3).

After the first iteration is completed and the cutoff is updated, all other bins can be scheduled to be processed simultaneously. Alternatively, in an embodiment of the invention, the remaining bins can be processed in groups: One group of bins is processed simultaneously, followed by a cutoff update. Then, the next group of bins is processed using the new cutoff. This approach has the advantage of an increasing the cutoff for later groups. Deciding the best strategy is an open question, and the answer depends on the dataset size and number of bins.

Another aspect is choosing which bin to start with. A small bin may be good since it takes less time. On the other hand, a bin with many outliers may be good since a higher cutoff will reduce computation time for other bins. A combination of the size and variance of a bin may be used to determine a bin's suitability to be the first one.

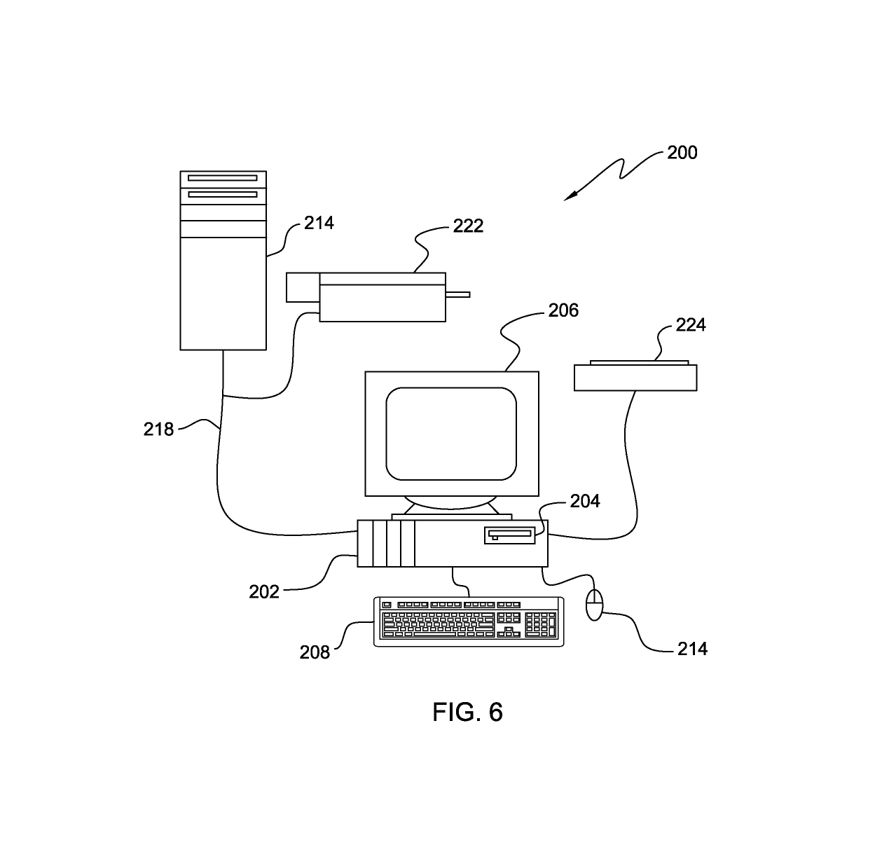

A computer-based system 200 in which a method embodiment of the invention may be carried out is depicted in FIG. 6. The computer-based system 200 includes a processing unit 202, which houses a processor, memory and other systems components (not shown expressly in the drawing) that implement a general purpose processing system, or computer that may execute a computer program product. The computer program product may comprise media, for example a compact storage medium such as a compact disc, which may be read by the processing unit 202 through a disc drive 204, or by any means known to the skilled artisan for providing the computer program product to the general purpose processing system for execution thereby.

The computer program product may comprise all the respective features enabling the implementation of the inventive method described herein, and which—when loaded in a computer system—is able to carry out the method. Computer program, software program, program, or software, in the present context means any expression, in any language, code or notation, of a set of instructions intended to cause a system having an information processing capability to perform a particular function either directly or after either or both of the following: (a) conversion to another language, code or notation; and/or (b) reproduction in a different material form.

The computer program product may be stored on hard disk drives within processing unit 202, as mentioned, or may be located on a remote system such as a server 214, coupled to processing unit 202, via a network interface 218 such as an Ethernet interface. Monitor 206, mouse 214 and keyboard 208 are coupled to the processing unit 202, to provide user interaction. Scanner 224 and printer 222 are provided for document input and output. Printer 222 is shown coupled to the processing unit 202 via a network connection, but may be coupled directly to the processing unit. Scanner 224 is shown coupled to the processing unit 202 directly, but it should be understood that peripherals might be network coupled, or direct coupled without affecting the performance of the processing unit 202.

While it is apparent that the invention herein disclosed is well calculated to fulfill the objectives discussed above, it will be appreciated that numerous modifications and embodiments may be devised by those skilled in the art, and it is intended that the appended claims cover all such modifications and embodiments as fall within the true spirit and scope of the present invention.

1. A method of detecting outliers in a set of data points, comprising:
partitioning the set of data points into a plurality of bins, where each of the data points is assigned to a respective one of the bins, and each of the bins has less than a defined number of the data points;
forming a plurality of local lists in parallel identifying a plurality of the points in the bins as outliers, each of the local lists identifying one or more outliers in a respective one of the bins; and
merging the local lists into a global list to identify one or more of the points in the set of data points as outliers of the data set.

2. The method according to claim 1, wherein the forming the plurality of local lists in parallel includes
for each point in each of the bins, identifying a k number of the other points in the data set that are the k nearest neighbors of said each point.

3. The method according to claim 2, wherein the forming the plurality of local lists further includes:
for each of at least some of the points in each of the bins, maintaining a knn list of the kth nearest neighbors of said each of the at least some of the points; and
using the knn lists to determine the one or more outliers of each of the bins.

4. The method according to claim 3, wherein the merging the local lists into a global list includes:
identifying all of the outliers of each of the bins on the global list; and
using the knn lists of said all of the outliers of each of the bins to identify a group of top outliers of the data set.

5. The method according to claim 2, wherein said identifying includes
determining for each of the points in each of the bins, other points in said each of the bins that cannot be one of the k nearest neighbors of said each point.

6. The method according to claim 2, wherein the determining includes
determining for each of at least some of the points in the data set, whether all of the points in any one of the bins cannot be one of the k nearest neighbors of said each of at least some of the points.

7. The method according to claim 1, wherein the forming the plurality of local lists in parallel includes
for each point in the data set, keeping track of the number of other points in the data set that are closer than a defined distance to said each point.

8. The method according to claim 7, wherein the forming the plurality of local lists in parallel further includes
for each point in the data set, when said number of other points in the data set that are closer than the defined distance to said each point exceeds a defined value, eliminating said each point from further consideration as an outlier.

9. The method according to claim 7, wherein the forming the plurality of local lists further comprises:
iterating over the bins a plurality of times to identify the other points in the data set that are closer than the defined distance to said each point; and
in the first of said iterations, setting said defined distance to zero.

10. The method according to claim 9, wherein the forming the plurality of local lists further comprises
in each of said iterations after said first of the iterations, updating said defined distance one or more times.

11. A system for detecting outliers in a set of data points, comprising one or more processing units configured for:
partitioning the set of data points into a plurality of bins, where each of the data points is assigned to a respective one of the bins, and each of the bins has less than a defined number of the data points;
forming a plurality of local lists in parallel identifying a plurality of the points in the bins as outliers, each of the local lists identifying one or more outliers in a respective one of the bins; and
merging the local lists into a global list to identify one or more of the points in the set of data points as outliers of the data set.

12. The system according to claim 11, wherein the forming the plurality local lists in parallel includes
for each point in each of the bins, identifying a k number of the other points in the data set that are the k nearest neighbors of said each point;
for each of at least some of the points in each of the bins, maintaining a knn list of the k nearest neighbors of said each of the at least some of the points; and
using the knn lists to determine the one or more outliers of each of the bins.

13. The system according to claim 12, wherein the merging the local lists into a global list includes:
identifying all of the outliers of each of the bins on the global list; and
using the knn lists of said all of the outliers of each of the bins to identify a group of top outliers of the data set.

14. The system according to claim 12, wherein said identifying includes
determining for each of the points in each of the bins, other points in said each of the bins that cannot be one of the k nearest neighbors of said each point.

15. The system according to claim 11, wherein the forming the plurality of local lists comprises:
iterating over the bins a plurality of times to identify, for each point in the bins, other points in the data set that are closer than a defined distance to said each point;
in the first of said iterations, setting said defined distance to zero; and
in each of said iterations after said first of the iterations, updating said defined distance one or more times.

16. An article of manufacture comprising:
one or more tangible program storage devices tangibly embodying a program of instructions executable by one or more processing units to perform method steps for detecting outliers in a set of data points, said method steps comprising:
partitioning the set of data points into a plurality of bins, where each of the data points is assigned to a respective one of the bins, and each of the bins has less than a defined number of the data points;
forming a plurality of local lists in parallel identifying a plurality of the points in the bins as outliers, each of the local lists identifying one or more outliers in a respective one of the bins; and
merging the local lists into a global list to identify one or more of the points in the set of data points as outliers of the data set.

17. The article of manufacture according to claim 16, wherein the plurality of local lists are formed by:
for each point in each of the bins, identifying a k number of the other points in the data set that are the k nearest neighbors of said each point;
for each of at least some of the points in each of the bins, maintaining a knn list of the k nearest neighbors of said each of the at least some of the points; and
using the knn lists to determine the one or more outliers of each of the bins.

18. The article of manufacture according to claim 17, wherein the local lists are merged into the global list by:
identifying all of the outliers of each of the bins on the global list; and
using the knn lists of said all of the outliers of each of the bins to identify a group of top outliers of the data set.

19. The article of manufacture according to claim 17, wherein said identifying includes:
determining for each of the points in each of the bins, other points in said each of the bins that cannot be one of the k nearest neighbors of said each point; and
determining for each of at least some of the points in the data set, whether all of the points in any one of the bins cannot be one of the k nearest neighbors of said each of at least some of the points.

20. The article of manufacture according to claim 17, wherein the forming the plurality of local lists in parallel includes:
for each point in the data set, keeping track of the number of other points in the data set that are closer than a defined distance to said each point;
for each point in the data set, when said number of other points in the data set that are closer than the defined distance to said each point exceeds a defined value, eliminating said each point from further consideration as an outlier;
iterating over the bins a plurality of times to identify the other points in the data set that are closer than the defined distance to said each point;
in the first of said iterations, setting said defined distance to zero; and
in each of said iterations after said first of the iterations, updating said defined distance one or more times.
